(19) United States
(12) Patent Application Publication
(10) Pub. No.: US 2018/0124374 A1
(43) Pub. Date: May 3, 2018

(54) System and Method for Reducing System Requirements for a Virtual Reality 360 Display

(71) Applicant: Ashley Brian Smith, Kemp, TX (US)

(72) Inventor: Ashley Brian Smith, Kemp, TX (US)

(73) Assignee: Ashcorp Technologies, Kemp, TX (US)

(21) Appl. No.: 15/680,067

(22) Filed: Aug. 17, 2017

Related U.S. Application Data
(63) Continuation-in-part of application No. 14/812,880, filed on Jul. 29, 2015.
(60) Provisional application No. 62/156,266, filed on May 3, 2015.
(60) Provisional application No. 62/031,437, filed on Jul. 31, 2014.

(51) Int. Cl. H04N 13/00; H04N 21/2187; H04N 21/414; H04N 21/4223; H04L 29/06; G06F 3/01

(52) U.S. Cl. CPC H04N 13/0014; H04N 13/0429; H04N 21/2187; H04N 21/41407; G06F 3/012; H04N 13/0059; H04N 13/0051; H04L 67/38; H04N 21/4223

(57) ABSTRACT

According to an embodiment of the disclosure, a system and method for displaying streamed video comprises one or more capturing devices and one or more servers. Each of the one or more capturing devices have a plurality of sensors configured to capture light used in forming image frames for a video stream. The sensors are arranged around a shape to capture the light at different focal points and at different angles. The servers are configured to receive light data from the capturing devices, store the data from the capturing devices, and provide a dynamically user-selected less-than-360-degree subset of the light data captured by the plurality of sensors to a remote end user as a stream of image frames for a video stream. The subset of the light data provided by the one more servers at a particular instance depend on selections from the end user's viewing device.

### CROSS-REFERENCE TO RELATED APPLICATIONS

This application is a Continuation-In-Part of pending U.S. patent application Ser. No. 14/812,880 filed Apr. 24, 2015, for which priority is claimed and is incorporated herein by reference in its entirety; and claims the benefit of U.S. Provisional Patent Applications Ser. No. 62/156,266 filed May 3, 2015 and 62/031,437 filed Jul. 31, 2014.

### BACKGROUND

### Field of Invention

The invention relates to the system and method of displaying an abbreviated virtual reality 360-degree image without reducing the user experience.

### Background of the Invention

The present invention is a useful and novel method for providing a human user with the experience of being in a 360-degree virtual reality (VR360) experience while reducing systems resources by not providing a full 360-degree video feed.

Virtual reality (VR) is a misused term that encompasses a range of distinctive technologies. Virtual reality is simply the display of what appears to be a three-dimensional (3D) image. Today, we assume the image is electronically produced and displayed. However, 3D images have been displayed since the early 1800s in what was called stereoscope. Humans perceive depth because of the space between our eyes. Like VR, stereoscope presents a different image for each eye (L/R images). When viewed with both eyes, the two images produce the appearance of a single 3D image, or anaglyph image. This can be reproduced by alternately closing the left and right eyes while reading this document. The image jumps left to right and centers again when both eyes are opened. VR simply recreates this exercise. The L/R images are shifted only slightly apart along the horizontal vision.

In the mid-1800s, David Brewster, invented the lenticular stereoscope with the introduction of lenses to combine the L/R images. This allowed the stereoscope to be portable and led to the familiar View-Master. The View-Master, still sold today, produces a 3D VR still image. Newer models of the View-Master blur the line of lenticular stereoscope by offering a VR360 still image using a smartphone (even including sound).

In motion picture theaters, 3D images are produced by projecting the L/R images from two projectors onto the same screen. The user wears polarized eyeglasses that allow each eye to discern a different image.

As such, what we think of as VR360 is not virtual reality as it was first conceived. Also, 360-degree video, by itself, is not necessarily virtual reality. For the purposes of this application VR360 will refer to a stream of L/R images presented to a user, using special electronic equipment, expecting a 360-degree immersion experience. This includes ‘room scale’ solutions that allows the user to walk around in the video or interact in other physical ways. The user is actually only able to observer at any given moment, through peripheral vision, 180 to 220 degrees on their visual horizontal plane (temporarily), 50 degrees upward (superiorly) and 60 to 70 degrees downward (inferiorly).

The L/R images are traditionally created with cameras with stereoscopic lenses: one camera lens for the left eye and one camera lens for the right eye. The two images are stored separately and presented simultaneously to the user employing a viewing device.

However, digital software also exists that can take a 2D video and create L/R images by adding the eye separation distance (disparity cue) to simulate depth. This is becoming more and more common because it provides cost and post-production advantages. Today, most non-CGI 3D films are converted from a 2D video. While today this is done on a server, it is not hard to imagine the viewing devices of the future would be able to do the conversion from a 2D video feed.

No matter the method used to create the L/R image, the systems in the prior art require a production software that takes the adjacent sensors, pre-stitches them into a single file. The production file is then adjusted for visual clutter created by combining the individual sensors into a single file. The clutter can include adjusting distance, size, opacity, and clarity. After the adjustment are made, either manually or with a software sweep, the single file is stored with the entire VR 360 images created by the sensors.

All the VR360 systems heretofore known suffer from a number of disadvantages:
1. Require pre-production of the virtual reality experience;
2. Transmit the entire VR 360 frames, even if not used by the consumer;
3. Require large bandwidth to transmit high definition experiences;
4. Require significant buffering delay to allow a continuous experience;
5. Require large storage requirements, at both the server and viewer, because they transmit unused portions of video.

### SUMMARY OF THE INVENTION

An invention, which meets the needs stated above, is a system and method to provide a VR360 experience without transmitting a full 360-degree view to the viewing device.

### Objects and Advantages

Accordingly, besides the objects and advantages of the System and Method for Reducing System Requirements for a Virtual Reality 360 Display, described above, several objects and advantages of the present invention are:
a) to provide a full VR360 experience to a user through a viewing device of choice;
b) to provide the viewing device's switches to signal the server to transmit a slice from the identified cameras;
c) to provide a reduction in bandwidth requirements;
d) to provide a reduction in storage requirements;
e) to provide a method to eliminate pre-production.

Further objects and advantages of this invention will become apparent from a consideration of the drawings and the ensuing description of the drawings.

### SUMMARY OF THE DISCLOSURE

According to an embodiment of the disclosure, a system for displaying streamed video from a distance comprises one or more capturing devices and one or more servers. Each of the one more capturing device have a plurality of sensors configured to capture light used in forming image frames for a video stream. The plurality of sensors is arranged around a shape to capture the light at different focal points and at different angles. The one or more servers are configured to receive light data from the one or more capturing devices, and to provide a dynamically user selected subset of the light data captured by the plurality of sensors to a remote end user as a stream of image frames for a video stream. The subset of the light data provided by the one more servers at a particular instance depend on selections from the end user.

### DRAWING FIGURES

The accompanying drawings, which are incorporated in and constitute a part of this specification, illustrate embodiments of the present invention and together with the description, serve to explain the principles of this invention. In the figures:

FIG. 1.—Simplified block diagram illustrative of a communication system that can be utilized to facilitate communication between endpoints through a communication network 130, according to particular embodiments of the disclosure;

FIG. 2.—A simplified block diagram showing a simplified system, according to an embodiment of the disclosure;

FIG. 3.—A simplified block diagram representing non-limiting examples of the viewer, according to an embodiment of the disclosure;

FIG. 4.—A simplified block diagram characterizing the subcomponents of a head movement tracker, according to an embodiment of the disclosure;

FIG. 5.—A simplified block diagram outlining subcomponents of a focus detection component, according to an embodiment of the disclosure;

FIG. 6.—Drawing depicting a plurality of capturing devices, according to an embodiment of the disclosure;

FIGS. 7 & 8.—Representative menus show example uses, according to an embodiment of the disclosure;

FIG. 9.—Drawing illustrating an embodiment of a general-purpose computer that may be used in connection with other embodiments of the disclosure to carry out any of the above-referenced functions and/or serve as a computing device for endpoint(s).

FIG. 10A-F.—Drawings depicting the generation of the L/R images from a cluster of sensors.

FIG. 11.—Drawing showing the arrangement and selection of sensors to produce the L/R images.

FIG. 12.—Flowchart and depicting switch, stitch, pitch and ditch image processing for 3D 360 experience.

### KEY TERMS

3D: displaying an image that has the appearance of depth with some objects closer and some objects further away.

360: displaying an image that provides the user the perception they have a 360-horizontal view surrounding their person.

Anaglyph image: The result when L/R images are combined by the mind with the use of tool.

L/R images: two separate images presented to each eye to produce a 3D effect.

VR360: a system of cameras, servers and viewers that provide human users with the experience of being in a manufactured video experience that closely resembles being present at the actual event. The user is able to turn all 360 degrees and see objects at each degree. Using L/R images, the video presents a 3D virtual reality effect.

### REFERENCE NUMERALS IN DRAWINGS

100 Communication systems
110 Endpoint
115 Link
120 Endpoint
125 Link
130 Communication network
140 Imaging system
150 Controller
200 Capturing device
210 Sensor, sensor feed
220 Shape for mounting sensors
230 Server
232 Request
234 Return information
240 Display server
242 Request
244 Return information
250 Viewing device
260 Switch
300 Glasses
310 Display
320 Head movement tracker
321 Accelerometer
323 Gyroscope
325 Compass
327 Accelerometer
329 Propagated signal detector
330 Speaker
340 Communication
350 Geolocation
360 Camera
370 Focus detection
371 Camera for focus detection
373 Light emission and detection
375 Eye detectors
380 Other component
600 Capturing device
600a-f Capturing device
610 Sensors
620 Camera mount, shape
700 Virtual screen
710a-h Applications
720 Hand
810a-d Selectable items
910 Computer
912 Processor
914 RAM
916 ROM
918 Mouse
920 Keyboard
922 Disk drive
924 Printer
926 Display
928 Communication link
1000 Sensor
1010 Left image
1020 Right image
1030 Image
1040 Center point
1050 Adjacent sensor
1060 Spatial map of sensors
1100 Sensors
1110 User
1210 Video capture
1220 Video feed stored in ROM
1222 Event identification tags added
1225 Display server waits for switch from viewing device
1230 Switch generated by viewing device (“switch”)
1240 Based on switch, selected video fee uploaded to RAM
1250 Selected videos stitched, trimmed on processor (“stitch”)
1260 Pitch the video to the viewer
1270 Clear RAM
1280 Stitched video displayed on viewer
1290 Display server

### DETAILED DESCRIPTION OF THE DRAWINGS

Not everyone has the opportunity of a much envied 50-yard line tickets at a college or professional football game. And, not everyone has the time in their schedule to attend the wedding of a friend of loved ones or a concert from their favorite band. Moreover, the videos of such events don't substitute for actually being at the actual event. The viewer of the videos must watch what the cameraman or producer viewed important.

Given concerns such as these, embodiments of the disclosure provide a system that emulates the switching of information one chooses to see, for example, based on movement of their head and eyes, but at a distance from the actual event. According to particular embodiments of the disclosure, the switched information provided to the user may be the next best thing to actual being at the event (or perhaps even better because of rewind capability). According to particular embodiments, the information can be played back in real time, later played back, and even rewound for a selection of a different view than selected the first time.

Referring to the drawings, in which like numerals represent like elements:

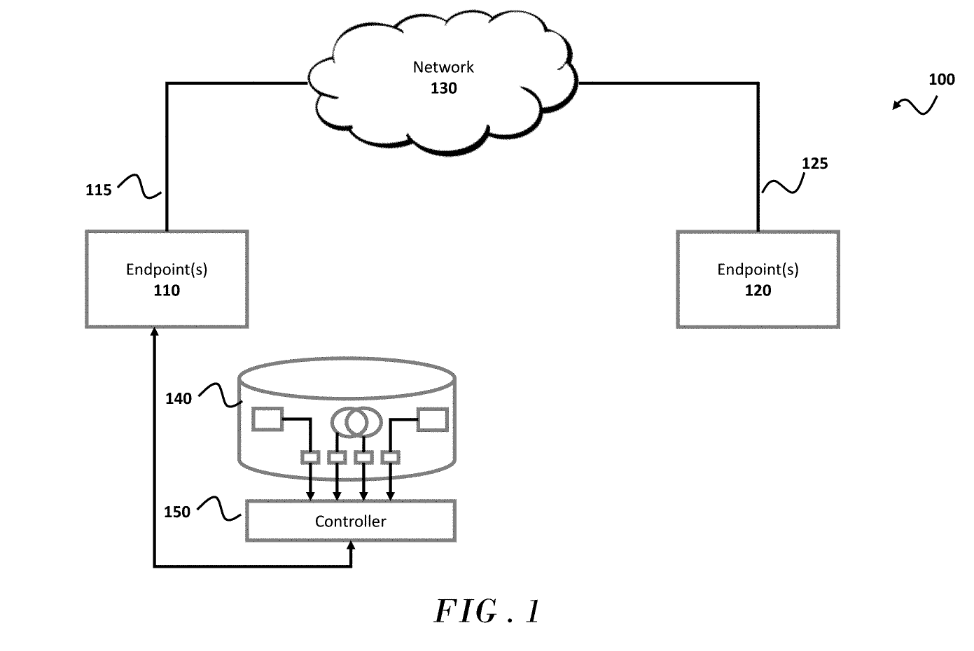

FIG. 1

Turning to FIG. 1, the block diagram illustrates a communication system 100 that can be utilized to facilitate communication between endpoint(s) 110 and endpoint(s) 120 through a communication network 130, according to particular embodiments of the disclosure. As used herein, “endpoint” may generally refer to any object, device, software, or any combination of the preceding that is generally operable to communicate with another endpoint. In certain configurations, the endpoint(s) may represent a user, which in turn may refer to a user profile representing a person. The user profile may comprise, for example, a string of characters, a user name, a passcode, other user information, or any combination of the preceding. Additionally, the endpoint(s) may represent a device that comprises any hardware, software, firmware, or combination thereof operable to communicate through the communication network 130. The communication system 100 further comprises an imaging system 140 and a controller 150.

Examples of an endpoint(s) include, but are not necessarily limited to, a computer or computers (including servers, applications servers, enterprise servers, desktop computers, laptops, netbooks, tablet computers (e.g., IP AD), a switch, mobile phones (e.g., including iPHONE and Android-based phones), networked televisions, networked watches, networked viewing devices 250, networked disc players, components in a cloud-computing network, or any other device or component of such device suitable for communicating information to and from the communication network 130. Endpoints may support Internet Protocol (IP) or other suitable communication protocols. In particular configurations, endpoints may additionally include a medium access control (MAC) and a physical layer (PHY) interface that conforms to IEEE 801.11. If the endpoint is a device, the device may have a device identifier such as the MAC address and may have a device profile that describes the device. In certain configurations, where the endpoint represents a device, such device may have a variety of applications or “apps” that can selectively communicate with certain other endpoints upon being activated.

The communication network 130 and links 115, 125 connected to the communication network 130 may include, but are not limited to, a public or private data network, a local area network (LAN), a metropolitan area network (MAN), a wide area network (WAN), a wireline or wireless network (e.g., WIFI, GSM, CDMA, LTE, WIMAX, BLUETOOTH or the like), a local, regional, or global communication network, portions of a cloud-computing network, a communication bus for components in a system, an optical network, a satellite network, an enterprise intranet, other suitable communication links, or any combination of the preceding. Yet additional methods of communications will become apparent to one of ordinary skill in the art after having read this specification. In particular configuration, information communicated between one endpoint and another may be communicated through a heterogeneous path using different types of communications. Additionally, certain information may travel from one endpoint to one or more intermediate endpoint before being relayed to a final endpoint. During such routing, select portions of the information may not be further routed. Additionally, an intermediate endpoint may add additional information.

Although an endpoint generally appears as being in a single location, the endpoint(s) may be geographically dispersed, for example, in cloud computing scenarios. In such cloud computing scenarios, an endpoint may shift hardware during back up. As used in this document, “each” may refer to each member of a set or each member of a subset of a set.

When the endpoints(s) 110, 120 communicate with one another, any of a variety of security schemes may be utilized. As an example, in particular embodiments, endpoint(s) 110 may represent a client and endpoint(s) 120 may represent a server in client-server architecture. The server and/or servers may host a website. And, the website may have a registration process whereby the user establishes a username and password to authenticate or log in to the website. The website may additionally utilize a web application for any particular application or feature that may need to be served up to website for use by the user.

According to particular embodiments, the imaging system 140 and controller 150 are configured to capture and process multiple video and/or audio data streams and/or still images. In particular configurations as will be described below, imaging system 140 comprises a plurality of low latency, high-resolution cameras, each of which is capable of capturing still images or video images and transmitting the captured images to controller 150. By way of example, in one embodiment, imaging system 140 may include eight (8) cameras, arranged in a ring, where each camera covers 45 degrees of arc, to thereby provide a complete 360-degree panoramic view. In another embodiment, imaging system 140 may include sixteen (16) cameras in a ring, where each camera covers 22.5 degrees of arc, to provide a 360-degree panoramic view.

In an example embodiment, one or more of the cameras in imaging system 140 may comprise a modification of an advanced digital camera, such as a LYTRO ILLUM™ camera (which captures multiple focal lengths at the same time), and may include control application that enable zooming and changing the focus, depth of field, and perspective, after a picture has already been captured. Additional information about the LYTRO ILLUM™ camera may be found at www.iytro.com. Yet other light field cameras may also be used. In particular embodiments, such light field cameras are used to capture successive images (as frames in a video) as opposed to one image at a time.

Either separate from or in conjunction with such cameras, a variety of microphones may capture audio emanating towards the sensors from different locations.

In certain embodiments, controller 150 is operable, in response to commands from endpoint 110, to capture video streams and/or still images from some or all of the cameras in imaging system 140. Controller 150 is further configured to join the separate images into a continuous panoramic image that may be selectively sent to endpoint 110 and subsequently relayed to endpoint 120 via communication network 130. In certain embodiments, capture from each of the cameras and microphones is continuous, with the controller sending select information commanded by the endpoint. As a non-limiting example, that will be described in more detail below, the endpoint may specify viewing from a focal point at a particular angle. Accordingly, the controller will stream and/or provide the information corresponding to that particular focal point and angle, which may include stitching of information from more than one particular camera and audio gathered from microphones capturing incoming audio.

In an advantageous embodiment, a user of endpoint 120 may enter mouse, keyboard, and/or joystick commands that endpoint 120 relays to endpoint 110 and controller 150. Controller 150 is operable to receive and to process the user inputs (i.e., mouse, keyboard, and/or joystick commands) and select portions of the continuous panoramic image to be transmitted back to endpoint 120 via endpoint 110 and communication network 130. Thus, the user of endpoint 110 is capable of rotating through the full 360-degree continuous panoramic image and can further examine portions of the continuous panoramic image in greater detail. For example, the user of endpoint 110 can selectively zoom one or more of the cameras in imaging system 140 and may change the focus, depth of field, and perspective, as noted above. Yet other more advanced methods of control will be described in greater detail below with reference to other figures.

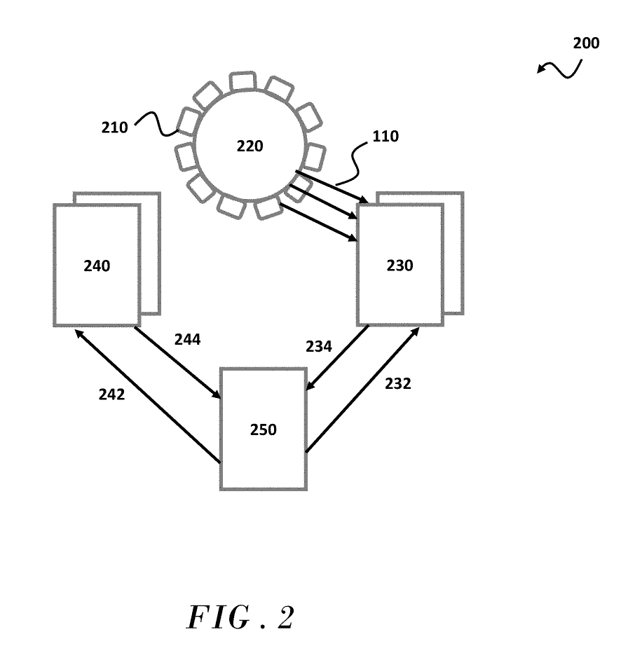

FIG. 2

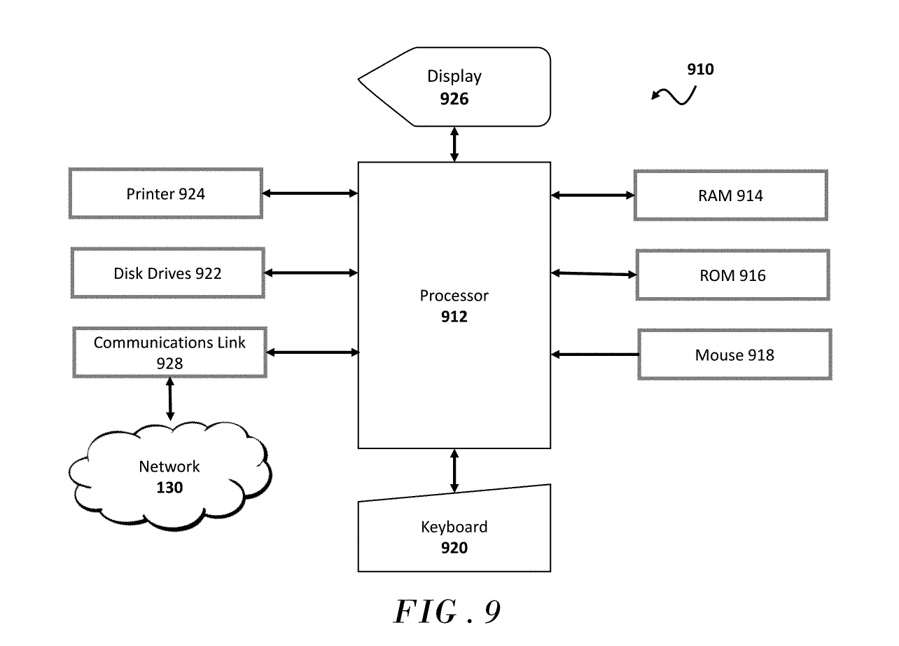

Referring now to FIG. 2, the block diagram shows a simplified system, according to an embodiment of the disclosure. The system may use some, none, or all of the components described with reference to FIGS. 1 and 9. Additionally, although a particular simplified discussion of components will be described, one should recognize that more, less, or fewer components may be used in operation.

The system of FIG. 2 includes a capturing device 200. The capturing device 200 has been simplified for purposes of illustration. The capturing device 200 in this view generally shows a plurality of sensors 210 mounted on a cylindrical shape 220. Although a cylindrical shape 220 is shown for this simplified illustration, a variety of other shapes may also be utilized. For example, the sensors 210 may be mounted around a sphere to allow some of the angles, to create a VR360 experience that will be viewed according to embodiments of the disclosure. Additionally, although only eight sensors 210 are shown, more than or less than eight sensors 210 may be used. In particular configurations, thousands of sensors 210 may be placed on the shape 220. Additionally, the sensors 210 may be aligned in rows. For example, the sensors 210 may be considered a cross section for one row of sensors 210 aligned along a column—extending downward into the page. Moreover, the sensors 210 may only surround portions of a shape—if only information from a particular direction is desired. For example, the field of view of gathered information may be along an arc that extends 135 degrees. As another example, the field of view may be along a portion of an oval for 220 degrees. Yet other configurations will become apparent to readers after review of this specification.

In particular embodiments, multiple cameras may be pointed at the same location to enhance the focal point gathering at a particular angle. For example, a first light field camera may gather focal points for a first optimum range, a second light field camera may gather focal points at a second optimal range, and a third light field camera may gather focal points for a third optimal range. Thus, a user who chooses to change the focal point may receive information from different cameras. The same multiple cameras for multiple focal points may also be used in scenarios where non-light field camera are used, for example, instead using cameras with relatively fixed focal points and switching between cameras as a different focal point is used. In the switching between cameras of different focal points (using light field cameras or not), stitching may be used to allow a relatively seamless transition. In particular embodiments, such stitching may involve digitally zooming on frames of images (the video) and then switching to a different camera. To enhance such seamless stitching, a variety of image matching technologies may be utilized to determine optimal points at which to switch cameras.

In particular configurations, the capturing device 200 may be stationary. In other configurations, the capturing device may be mobile. As a non-limiting example, the capturing device 200 may be mounted on an air-borne drone or other air-borne device. As another example, the capturing device may be mounted on a remotely controlled vehicle to survey an area. As yet another example, the capturing device may be mounted on a suspended wire system that are typically used in sporting events such as football.

In some configurations, the surveillance—either airborne or not—may be of a dangerous area. As non-limiting examples, one or more capturing devices may be placed on a robot to monitor a hostage situation. One or more capturing devices may also be placed at crime scenes to capture the details that may later be played back and reviewed over and over for details.

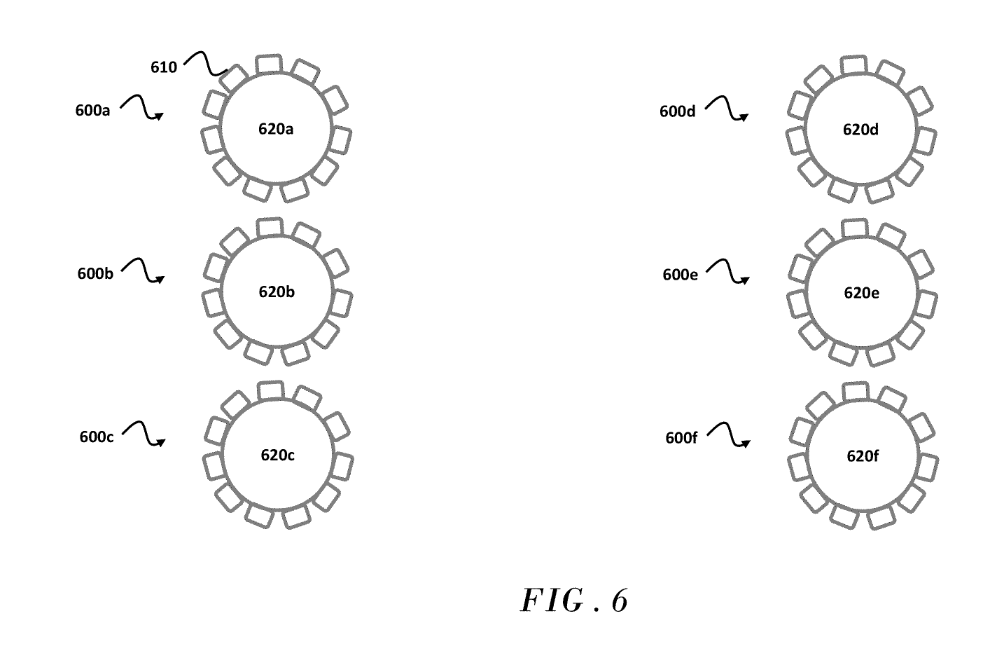

Although one capturing device 200 has been shown, more than one capturing device 200 may exist with switching (and stitching) between such capturing devices 200. For example, as will be described below with reference to FIG. 6 in scenarios involving panning, a user may virtually move from capturing device to capturing device.

The sensors 210 may be any suitable sensors configured to capture reflected light which, when combined, forms images or video. As a non-limiting example, as described above, modified LYTRA cameras may be utilized to capture light at multiple focal points over successive frames for video. In other embodiments, other types of cameras, including light field cameras, may also be utilized with cameras capturing different foci. In yet other embodiments, non-multiple-focus-at-the-same-time gathering cameras may also be used. That is, in other embodiments, cameras that have a particular focal point (as opposed to more than one) may be utilized.

Although the sensors 210 are generally shown as a single box, the box for the sensor 210 may represent a plurality of sensors that can capture multiple images. As a non-limiting example, a single LYTRA camera may be considered multiple sensors because of gathering light from multiple focal points.

In addition to light, the sensors 210 may capture audio from different angles. Any suitable audio sensor may be utilized. In particular embodiments, the audio—in similar fashion to the light sensors—may be directed to capture audio at different distances using different sensors.

The information captured by the capturing device 200 is sent to one or more servers 230 on a network 110. The one or more servers 230 can process the information for real-time relay for select portions to a viewing device 250. In alternative configurations, the one or more servers 230 can store the information for selective playback and/or rewind of information. As a non-limiting example, a viewer of a sports event may select particular view in a live stream and then rewind to watch a certain event multiple times to view such an event from different angles and/or focus.

In one particular configuration, the server 230 pieces together the various streams of information that have been sent from the capturing device 200 (or multiple capturing devices 200) that the viewing device 250 has requested. As a non-limiting example, the viewing device 250 may wish to view images or video (and audio) from a particular angle with a particular pitch at a particular focal point. The server 230 pulls the information the sensors 210 capturing such information and sends it to the viewing device 250. In some configurations, the relay of information may be real-time (or near real-time with a slight delay). In other configurations, the playback may be of information previously recorded. In addition to information switching from a particular capturing device 200 in particular configurations, the one or more servers 230 may also switch between different capturing devices 200 as will be describe with reference to FIG. 6.

In particular configurations, the information may be stitched—meaning information from more than one sensor is sent. As a simple example, an angle between two or more cameras may be viewed. The information from such two or more cameras can be stitched to display a single view from such multiple sensors. In particular configurations, stitching may occur at the one or more servers 230. In other configurations, stitching may occur at the viewing device 250.

In particular configurations, the stream of information stitching and relaying may be analogous to a function performed by a human eye when incoming light is switched to focus on a particular light stream. When audio is combined to this light switching, the viewed information may take on appearance as though one were actually present at the same location as the capturing device 200. Other switching of information may be analogous to eye and/or head movement of a user. The applications of the viewing of information captured by capturing devices 200 are nearly unlimited. As non-limiting examples, the capturing devices 200 can be placed at select locations for events—whether they be sporting events, concerts, or lectures in a classroom. Doctors and physicians may also use mobile versions of capturing devices 200 to virtually visit a patient remotely. Police enforcement may also use mobile versions of the capturing devices 200 (or multiple ones) to survey dangerous areas. Yet additional non-limiting examples will be provided below.

Any of the above-referenced scenarios may be viewed in a real-time (or near real-time) or recorded playback scenario (or both). For example, in watching a sport event (real-time or not), a user may pause and rewind to watch the event from a different angle (or from a different capturing device 200) altogether. Police may view the scene—again—looking at clues from a different angle or focus than previously.

The one or more servers 240 represent additional information that may be displayed to a user. In one configuration, the one or more servers 240 may display an augmented reality. In yet other configurations, only information from the one or more servers 240 may be displayed.

The viewing device 250 may be any suitable device for displaying the information. Non-limiting examples include glasses, projected displays, holograms, mobile devices, televisions, and computer monitors. In yet other configurations, the viewing device 250 may be a contact lens placed in one eyes with micro-display information. The request (generally indicated by arrow 232) for return information 234 may be initiated in a variety of different manners—some of which are described below.

As a first non-limiting example, the viewing device 250 may be glasses that are opaque or not. The glasses may be mounted with accelerometers, gyroscopes, and a compass, or any other suitable device such an inertial measurement units (IMUs), to detect the direction one's head (or in some scenarios, eyes) is facing. Such detected information can switch toward the collection of information in a particular direction. To obtain a particular focus of information, one may use hand gestures (haptics) that are detected by the glasses. Alternatively, the glasses can include a sensor to detect whether the eye is searching for a different focus and switch to that particular focus. Other devices for switching the input to the glasses may also be utilized.

In other configurations, yet other detection mechanisms may be included using input devices or hand gestures. As a non-limiting example, Meta (www.getmeta.com) has developed glasses 300 with sensors to detect hand movement with respect to such glasses. Such glasses can be augmented to switch streams being captured (or previously captured) from one or more capturing devices. Other technologies using reflected waves, image analysis of hands with pre-sets for a particular skeletal make-up of a user, may also be utilized according to embodiments of the disclosure.

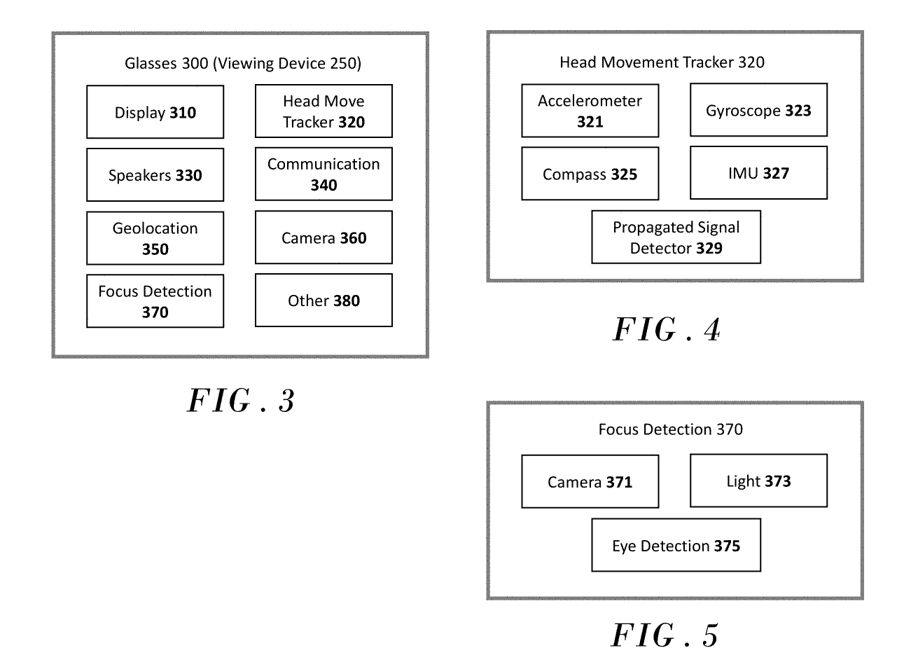

For other types of viewing devices 250 any suitable mechanism to switch the information stream may be utilized—including those mentioned above. For example, a standard tablet or smartphone can be moved around to view different views as though one were actually at the event. Accelerometers, gyroscopes, compasses and other tools on the smart phone may be used to detect orientation. Yet other components will be described below with reference to FIG. 3.

In one particular configuration, the viewing device may be a band worn on the arm that projects a display onto one's arm.

In particular configurations, in addition to the information captured by the capturing device 200 being displayed, information from the one more servers 240 may be displayed to augment the remotely-captured real-time (or near real-time) or previously recorded reality. As a non-limiting example, one watching a sporting event may identify a particular player and inquire as to such a player's statistical history. One or a combination of the viewing device 250, the one or more servers 230, and/or the one or more servers 240 may utilize any suitable technology to determine what a particular user is viewing and also to detect the switch 260 requested by the viewing device. The requested information 242 returns the information 244. A verbal request 242 may be recognized by one or a combination of the viewing device 250, the one or more servers 230, and/or the one or more servers 240.

In other configurations, information may be automatically displayed—in an appropriate manner. For example, in a football game, a first down maker may be displayed at the appropriate location.

In yet other configurations, standard production overlays may be displayed over a virtual (e.g., score of the game, etc.). These can be toggled on or off.

As another example of use of information from both the one or more servers 230 and one or more servers 240, a professor may give a lecture on an engine with the professor, himself, viewing the engine as an augmented reality. The wearer of the glasses may view the same engine as an augmented remote reality—again recorded or real-time (or near real-time) with a choice of what to view.

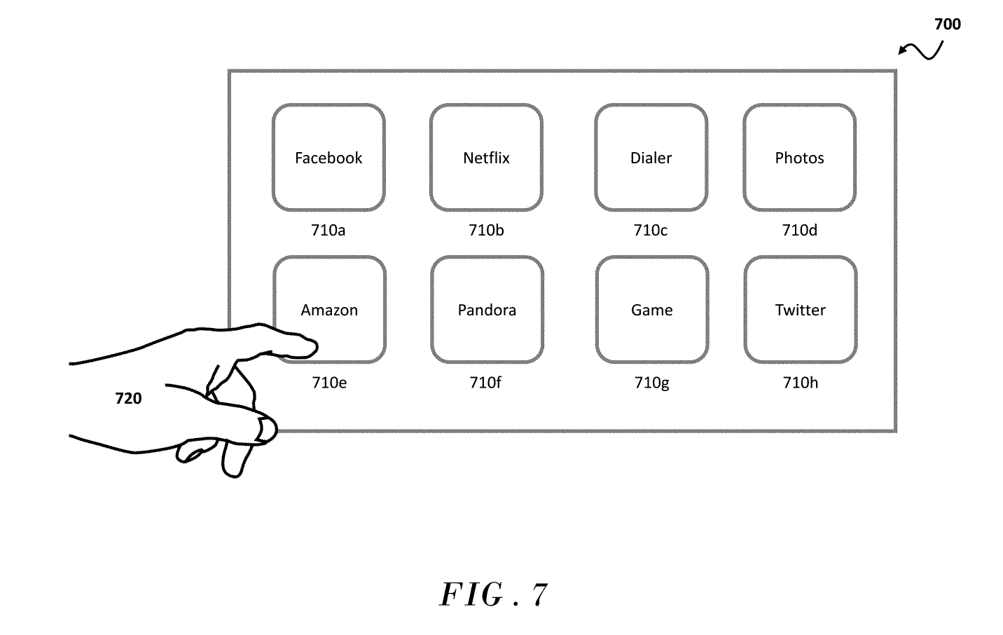

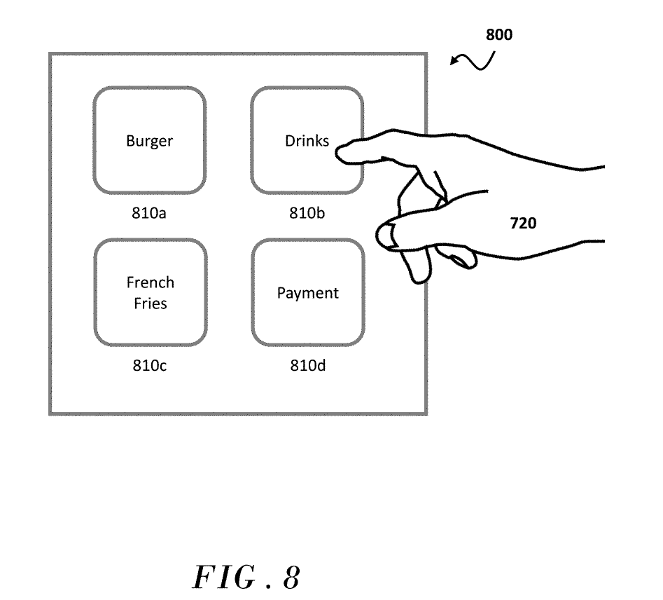

In particular configurations, only information from the one or more servers 240 is utilized forming an “Internet Wall” of sorts to allow a viewer to look at information. In such a configuration, where the viewing device 250 is glasses 300, a user can view information over the internet through various windows. However, the initiation of such applications can effectively be a typing or gesturing in the air. Further details of this configuration will be described below with reference to FIGS. 7 and 8.

In such configurations as the preceding paragraph, there is little fear of one viewing over your shoulder. The user is the only one able to see the screen. Thus, for example, when in a restaurant or on a plane, there is little fear that one will see private conversations or correspondence.

As yet another example, a user may be wearing the glasses 300 while driving down the road and order ahead using a virtual menu displayed in front of him or her. The user may also authorize payment through the glasses. Non-limiting examples of payment authorization may be a password provided through the glasses, the glasses already recognizing the retina of the eye, or a pattern of the hand through the air. Thus, once the user arrives at a particular location, the food will be ready and the transaction will already have occurred.

FIG. 3

FIG. 3 block diagram depicts non-limiting examples of glasses, according to an embodiment of the disclosure. The glasses 300 of FIG. 3 is one non-limiting example of a viewing device 250 of FIG. 2.

The glasses 300 of this embodiment is shown as including the following components: display 310, head movement tracker 320, speakers 330, communication 340, geolocation 350, camera 360, focus detection 370, and other 380. Although particular components are shown in this embodiments, other embodiments may have more, fewer, or different amounts of components.

The display 310 component of the glasses 300 provides opaque and/or transparent display of information to a user. In particular configurations, the degree of transparency is configurable and changeable based on the desired use in a particular moment. For example, where the user is watching a sporting event or movie, the glasses can transform to an opaque or near-opaque configuration. In other configurations such as augmented reality scenarios, the glasses can transform to a partially transparent configuration to show the portion of the reality that needs to be seen and the amount of augmentation of that reality.

The speakers 330 component provide an audio output to a user. The audio may or may not correspond to the display 310 component.

FIG. 4

In FIG. 4, the block diagram illustrates the head movement tracker 320 as having a variety of subcomponents: accelerometers 321, gyroscopes 323, compass 325, inertial measurement unit (IMU) 327, and a propagated signal detector 329. Although particular subcomponents of the head movement tracker 320 are shown in this embodiments, other embodiments may have more, fewer, or different amounts of components. In detecting movement of the head (through the glasses which are affixed) any, some, or all of subcomponents may be utilized. In particular configurations, some or all the components may be used in conjunction with one another. For example, in particular configurations, the IMU 327 may include an integrated combination of other subcomponents. A non-liming example of an IMU 327 that may be utilized in certain embodiments is the SparkFun 9 Degrees of Freedom Breakout (MPU-9150) sold by SparkFun Electronics of Niwot, Colo.

The propagated signal detector 329 may use any technique used, for example, by mobile phones in detecting position, but on a more local and more precise scale in particular configurations. For example, the glasses 300 may be positioned in a room with a signal transmission that is detected by multiple propagated signal detectors 329. For example, knowing the position of three propagated signal detectors on the glasses and the relative time difference of their receipt of the signal, the three-dimensional relative position of the glasses 300 can be detected. Although three propagated signal detectors are referenced in the preceding sentence, more than three propagated signal detectors may be utilized to enhance confidence of location. Although the term “relative” is utilized, a configuration of glasses upon set-up will determine the relative location for setup.

The other 380 component include any standard components that are typical of smartphones today such as, but not limited to, processors, memory, and the like.

FIG. 5

Referring now to FIG. 5, the drawings show the focus detection 370 component has a variety of subcomponents: camera 371, light emission and detection 373, and eye detectors 375. Although particular subcomponents of the head movement tracker 320 are shown, other embodiments may have more, fewer, or different amounts of components. Additionally, the focus may be detected using some, none, or all of these components.

The camera 371 (which may be more than one camera) may either be the same or separate from the camera 360 discussed above. In particular embodiments, the camera 371 may be configured to detect movement of one's hand. As an example, the focus may change based on a particular hand gesture to show the focus is to change (e.g., pinching). Yet other hand gestures may also be used to change focus. The camera 371 may also be used to manipulate or change augmented objects placed in front of the glasses. For example, one may have a virtual rotating engine providing different view points. In particular embodiments, such different viewpoints may be from various cameras, for example, in sporting events or in a reconnaissance type scenario as described herein.

The eye detection 375 component may be used to detect where a user is looking for information—using a sensor such a camera or an autorefractor. In particular embodiments, a focus can change based on changing parameters of the eye as measured by a miniaturized autorefractor. Additionally, when an eye looks in a different direction, a camera can detect the “whites” of one's eye veering in a different direction. Although the eye detection 375 component is used in particular configurations, in other configurations, the other components maybe utilized.

The light emission and detection 373 component emits a light for detection of the reflection by the camera or other suitable light detection. A user may place a hand in front of these detectors with gestures such as moving in or moving out to indicate a change of focus. The light emission and detection 373 component and any associated detectors can also be used to determine the direction of one's focus or changing of camera.

FIG. 6

FIG. 6 shows a plurality of capturing devices, according to an embodiment of the disclosure. The capturing devices 600a, 600b, 600c, 600d, 600e, and 600f may operate in the same or different manner to the capturing device 200 of FIG. 2 having a plurality of sensors 610 and mounted around a shape 620. FIG. 6 shows how embodiments may have a plurality of capturing devices 600 allowing movement between such devices. Although six capturing devices 600 are shown in this configuration, more than or less than six capturing devices may be used according to other embodiments.

As a first non-limiting example, capturing devices 600b and 600e may be positioned on the 50-yard line of a football field. Depending on where game play is occurring, a user may desire to switch capturing devices 600. Any suitable mechanism may be used. For example, a user may place both hands up in front of the glasses 300 and move them in one direction—left or right—to indicate movement between capturing devices. Such a movement may allow a pan switching between capturing device 600b to 600a or 600c. Another non-limiting example, a user may place both hands with a rotational movement to switch to the opposite side of the field, namely from capturing device 600b to 600e. A variety of other hand gestures should become apparent to one reviewing this disclosure.

In switching between one capturing device 600 to another, stitching may also be utilized to allow for relatively seamless transitions.

FIG. 7

Next, referring to FIG. 7, depicts the use of the invention to display an example use, according to an embodiment of the disclosure. FIG. 7 shows a virtual screen 700 that may appear in front of a user wearing the glasses 300 of FIG. 3. As described above, this may be viewed as an Internet wall of sorts that allows a user to privately see information in front of them—in an augmented reality type configuration. In particular embodiments where one of the cameras or other components on the glasses 300 is detecting a smooth surface (such as a desk or piece of paper), the virtual screen 700 may be displayed on the smooth surface. In other configurations where the augmented wall is appearing in space in front of the user, the user may be allowed to determine how far in front of him or her the wall is placed.

The particular virtual screen 700 shown in FIG. 7 is an application interface that allows a user to select one of a number of applications 710a, 710b, 710c, 710d, 710e, 710f, 710g, and 710h—according to an embodiment of the disclosure. The user selects the application by simply touching the respective icon on the virtual wall, for example, as illustrated by hand 720 moving towards the virtual screen 700. A virtual keyboard (not shown) can also pop-up to allow additional input by the user.

The virtual screen 700 may take on any of a variety of configurations such as, but not limited to, those provided by a smart phone or computer. Additionally, the virtual screen in particular embodiments may provide any content that a smart phone or computer can provide—in addition the other features described herein. For example, as referenced above, virtual augmented reality models can be provided in certain configurations. Additionally, the remote viewing of information gathered by, for example, one or more capturing devices 200 may also be displayed.

The following provides some non-limiting example configurations for use of the glasses 300 described with reference to FIG. 3.

The glasses 300 may be provided to visitors of a movie studio; however, rather than the viewers of the movie studio viewing a movie on the big screen, they will be viewing the content they choose to view by interacting with the glasses 300. The content may be any event (such a sporting event, concert, or play). In addition to information from the event, the viewer may choose supplemental content (e.g., statistics for a player, songs for a musician, or other theatrical events for an actor). Alternatively, the content may be a movie shot from multiple perspectives to provide the viewer a completely new movie viewing experience.

The particular configuration in the preceding paragraph may assist with scenarios where a user does not have the particular bandwidth capacity needed, for example, at home to stream content (which in particular configurations can become bandwidth intensive). Additionally, in particular embodiments, all the data for a particular event may be delivered to the movie theater for local as opposed to remote streaming. And, portions of the content are locally streamed to each respective viewing device 250, such as glasses 300, (using wired or wireless configurations) based on a user's selection. Moreover, in the streaming process, intensive processing may take place to stitch as appropriate information gathered from different sources.

In scenarios where bandwidth is adequate, in particular scenarios, a user may be allowed to view the content from home—in an on-demand type scenario for any of the content discussed herein. As referenced above, in such scenarios, stitching (across focus, across cameras, and across capturing devices) may either occur locally or remotely. And, in some configurations, certain levels of pre-stitching may occur.

As another non-limiting example, a user may have received content from a personal drone that allows view from different elevated perspective.

For example, a golfer may place the glasses 300 on to view an overhead of a layout of the course for strategies in determining how best to proceed. In reconnaissance type scenarios, a single drone may provide a plurality of personnel “visuals” on a mission—with each person choosing perhaps different things they want to look at.

As another example, a user may place a capturing device 200 on his or her self in GO-PRO-style fashion to allow someone else to view a plurality of viewpoints that the user himself would not necessarily view. This information may either be stored locally or communicated in a wireless fashion.

As yet another example, students in a classroom may be allowed to take virtual notes on a subject with a pen that specifically interoperates with the glasses 300. In such a scenario, the cameras 360 and/or other components of the glasses can detect a particular plane in front of the glasses (e.g., a desk). Thus, a virtual keyboard can be displayed on the desk for typing. Alternatively, a virtual scratch pad can also be placed on the desk for creating notes with a pen. In such scenarios, a professor can also have a virtual object and/or notes appear on the desk. For example, where the professor is describing an engine, a virtual representation of the engine may show up on the desktop with the professor controlling what is being seen. The user may be allowed to create his or her own notes on the engine with limited control provided by the professor.

As yet another example, deaf people can have a real-time speech-to-text input of interpreted spoken content displayed. Blind people can have an audio representation of an object in front of the glasses 300—with certain frequencies and/or pitches being displayed for certain distances of the object.

As yet another example, a K-9 robot device can be created with capturing devices mounted to a patrol unit used for security—with audio and visual views much greater than any human or animal. If any suspicious activity is detected in any direction, an alert can be created with enhanced viewing as to the particular location of the particular activity. For example, the K-9 device can be programmed to move toward the suspicious activity.

As yet another example, one giving a speech can be allowed access to his or her notes to operate in a virtual teleprompter type manner.

As yet another example, the glasses 300 may have image recognition type capabilities to allow recognition of a person—followed by a pulling up of information about the person in an augmented display. Such image recognition may tap into any algorithms for example, used by Facebook, in the tagging of different types of people. As a non-limiting example, such algorithms use characteristics such as space between facial features (such as eyes) to detect a unique signature for a person.

As yet another example, the glasses 300 may display a user's social profile page, which may be connected to more than one social profile like Google+, Facebook, Instagram, and Twitter.

FIG. 8

FIG. 8 depicts the use of the invention to demonstrate a user (but not the driver) heading down the road may use the viewing device 250 to make a food order that will be ready upon arrival. A user sees a virtual menu 800 of a variety of selectable items (e.g., hamburgers 810a, French fries 810b, and drinks 810c) and then checkout using any payment of method—indicated by payment button 810d. In particular scenarios, to ensure the food is warm, the location of the viewing device 250 and speed of travel can be calculated and sent to estimate a time of arrival.

FIG. 9

FIG. 9 is an embodiment of a general-purpose computer 910 that may be used in connection with other embodiments of the disclosure to carry out any of the above-referenced functions and/or serve as a computing device for endpoint(s) 110 and endpoint(s) 120. General purpose computer 910 may generally be adapted to execute any of the known OS2, UNIX, Mac-OS, Linux, Android and/or Windows Operating Systems or other operating systems. The general purpose computer 910, indicated on FIG. 9, in this embodiment includes a processor 912, a random access memory (RAM) 914, a read only memory (ROM) 916, a mouse 918, a keyboard 920 and input/output devices such as a printer 924, disk drives 922, a display 926 and a communications link 928. In other embodiments, the general purpose computer 910 may include more, less, or other component parts.

Embodiments of the present disclosure may include programs that may be stored in the RAM 914, the ROM 916 or the disk drives 922 and may be executed by the processor 912 in order to carry out functions described herein. The communications link 928 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding. Disk drives 922 may include a variety of types of storage media such as, for example, floppy disk drives, hard disk drives, CD ROM drives, DVD ROM drives, magnetic tape drives or other suitable storage media. Although this embodiment employs a plurality of disk drives 922, a single disk drive 922 may be used without departing from the scope of the disclosure.

Although FIG. 9 provides one embodiment of a computer that may be utilized with other embodiments of the disclosure, such other embodiments may additionally utilize computers other than general-purpose computers as well as general-purpose computers without conventional operating systems. Additionally, embodiments of the disclosure may also employ multiple general-purpose computers 910 or other computers networked together in a computer network. Most commonly, multiple general-purpose computers 910 or other computers may be networked through the Internet and/or in a client server network. Embodiments of the disclosure may also be used with a combination of separate computer networks each linked together by a private or a public network. Several embodiments of the disclosure may include logic contained within a medium. In the embodiment of FIG. 9, the logic includes computer software executable on the general-purpose computer 910. The medium may include the RAM 914, the ROM 916, the disk drives 922, or other mediums. In other embodiments, the logic may be contained within hardware configuration or a combination of software and hardware configurations.

The logic may also be embedded within any other suitable medium without departing from the scope of the disclosure.

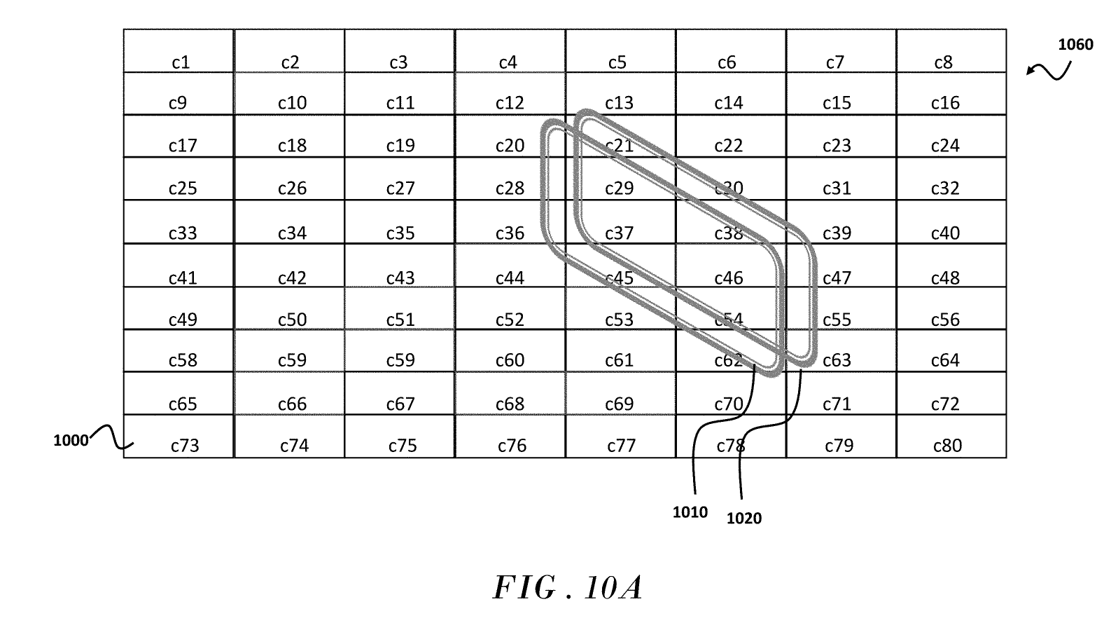

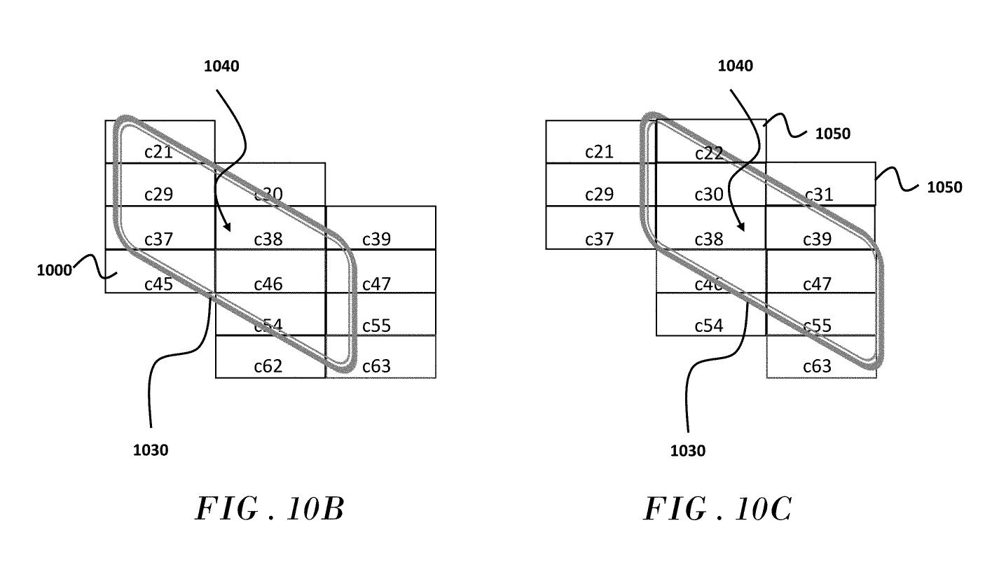

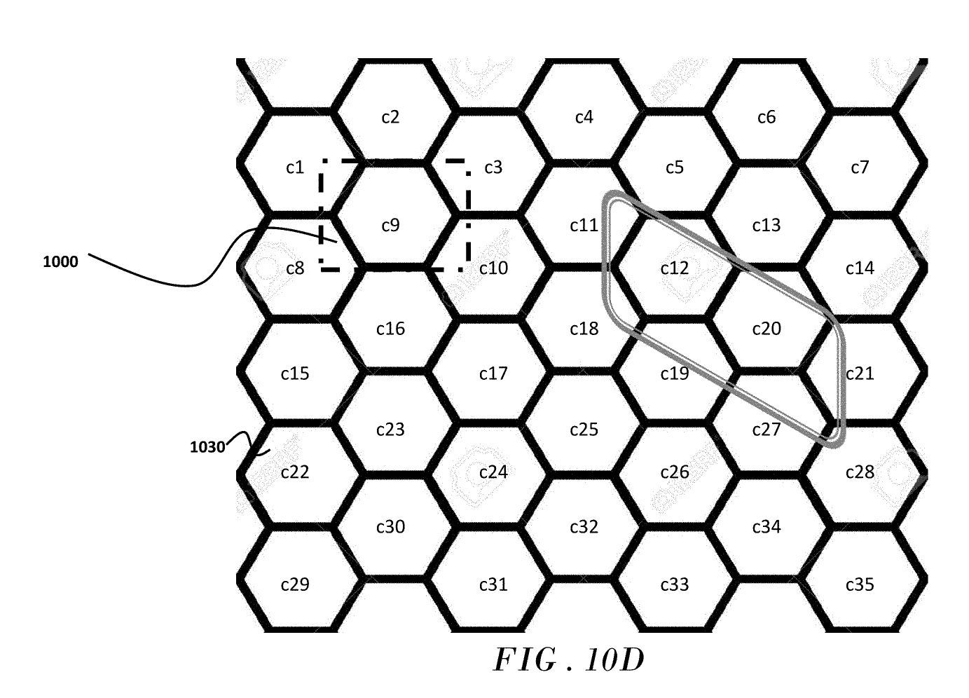

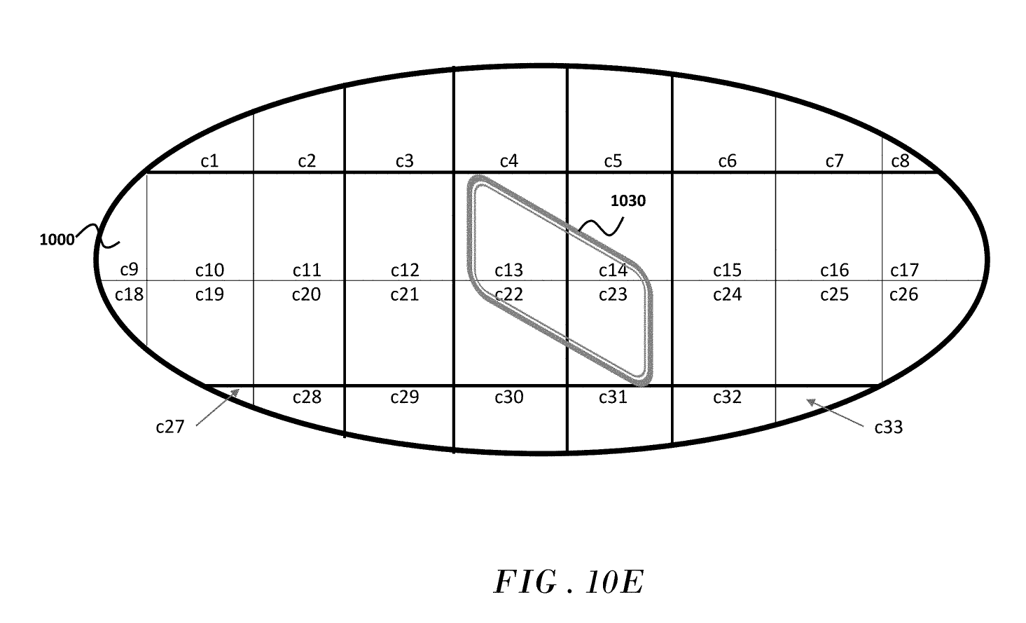

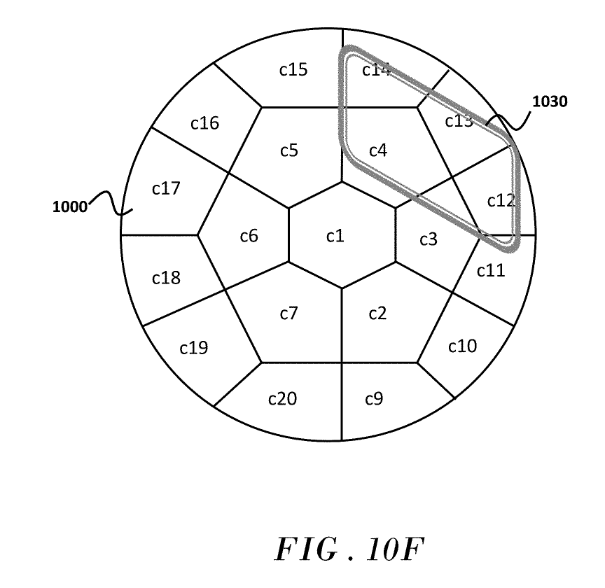

FIGS. 10A-E

FIGS. 10A through 10E are drawings demonstrating the use of the invention to collect successive and adjacent images 1050 from sensors to generate a VR360 experience. In 10A, each individual rectangle represents a stored image 1030 from a sensor 1000 or capturing device 200. The designation of, for example, c1 represent camera 1 with a total of 80 cameras in the camera mount 620, ranging from c1 to c80. A sensor 1000 may include the entire electro-magnetic spectrum, not just the visible portion, and may include infra-red technology. The stored images are available for later assembly into a stitched image ordered by the processor 912 and assembled in memory 914. The stored images c1 to c80 represent a 360-degree horizontal surround experience where c1 is an adjacent sensor 1050 to c8, c9 is adjacent to c16, c17 is adjacent to c24, etc. Row c73 to c80 represents a most inferior position captured by the camera mount 620 and row c1 to c8 represent the most superior position captured by sensors on the mount 620. The relationship between the adjacent sensors 1050 is stored in a spatial map 1060 stored in ROM 916 on the display server 1290.

The rounded, double-border rectangles represent the L/R images where the left image 1010 and right image 1020 use different sensors to create the stereopsis effect of a 3D environment. In humans, and many other animals, the separation of two eyes generates a 3D depth to an image, also referred to as binocular vision. In this embodiment, the separate collection of a left image 1010 and right image 1020 using different sensor 1000 clusters creates two streams of data. For the purposes of illustration:
The left image 1010 is generated with adjacent sensors 1050 of (moving top to bottom and the left to right) c20, c28, c36, c44, c21, c29, c37, c45, c53, c38, c46, c54, and c62.
Conversely, the right image 1020 is stitched with sensors 1000 of (moving top to bottom and the left to right) c21, c29, c37, c45, c30, c38, c46, c54, c62 c39, c47, c55, and c63.

This slight variation in sensor data recreates the eye separation of human users and presents two slightly different concurrent images 1030 to the user. When viewed together, the user's mind generates a 3D anaglyph.

If the user holds the viewing device 250 in place, and no other switches 260 are signaled, the L/R images will continue to collect recursively from the same sensors 1000.

In one embodiment, the cluster of sensors 1000 for the R/L images 1010,1020 are stitched from the entire image generated by the sensors employed. This eliminates processor time required to trim the images 1030 before the transfer of the two images 1030 to the viewing device 250. The result is a reduction in the display server's 1290 memory 914, processor 912, and communication link 928 requirements.

FIGS. 10B and 10C represent an embodiment when the viewing device 250 signals a switch 260, such as from a head movement or a camera for focus detection 371. In the present figures, each sensor 1000 presents two cameras 360 situated on the horizontal and sending separate right 1020 and left 1010 images. The initial image, FIG. 10B, is stitched in memory with adjacent sensors 1050 (moving top to bottom and the left to right) c21, c29, c37, c45, c30, c38, c46, c54, c62 c39, c47, c55, and c63. In the preferred embodiment, when the viewing device 250 signals a shift in focus from left (FIG. 10B) to right (FIG. 10C), the display server's 1290 memory 914 flushes adjacent sensors c45 and c62. Concurrently, the server 1290 stitches in c31 adjacent to c30 and c39; and c22 is stitched in as an adjacent sensor 1050 to c21 and c30. By holding the majority of cameras in memory, processing time is reduced. By replacing two of the sensors 1000 feeds with two adjacent sensor feeds 210, the memory 914 requirements remain the same.

The processor on the display server 1290 records the address of each sensor 1050 held in memory 914 where the address points to sensor files stored on the ROM 916 and available for rendering on the viewing device 250. As the display server 1290 flushes the memory 1270, the address is deleted and the sensor feed 210 is removed from memory. Concurrently, the server 1290 establishes a new memory address for the added adjacent sensors 1050 and supplies that stored image 1030 to the RAM 914. The memory 914 may represent multiple memory units and may be located remotely. Additional memory hardware may preload adjacent sensors 1050 predictively for rapid transfer to the central rendering memory.

As in FIG. 10A, each sensor's 1050 entire feed is sent untrimmed from the display server 1290 to the viewing device 250. By marking a center point 1040, the display is able to show the associated L/R images without also having to trim the images 1010, 1020 to match the L/R viewing size.

The system allows live production by pulling the original sensors 1000 based on the viewing device's 250 switch 1230, stitching them in memory 914, pitching the image to the viewing device 1260, and then discarding 1270 sensor feeds 210 when they are no longer needed to render the image 1030. In parallel, a structure file may improve the render by advising on object distances, opacity, size, clarity, etc.

FIG. 10D's drawing demonstrates a stitching technique embodiment. The individual feeds, numbered C1 through C35 represent a sensor 1000 captured in a rectangular outline, as shown in the dashed-line image. Each sensor captures a different scene that overlaps adjacent sensors 1050. The stitching is then accomplished by overlapping and matching the corners of the images 1030 with the adjacent sensors 1050. For purposes of illustration, the hexagon designated as c9 matches to the corner images of sensors c1, c3, c8, and c10. The result is the sensor c9 is trimmed into a hexagon and then stitched to the adjacent sensors 1050 to render the required image. This produces a seamless image stitched in the memory of the present invention and pitched to the viewing device 250.

FIG. 10E illustrates an embodiment that creates a VR360 view with a collection of trimmed and untrimmed sensors 1000. C11 through 16 and c20 though c24 are stitched untrimmed. The remaining sensors 1050 are trimmed and stitched to create the oval image transmitted to the viewing device. In the embodiment shown in FIG. 10F, the adjacent sensors 1050 themselves transmit irregularly shaped images that, when stitched in a predetermined order, form the circular pattern.

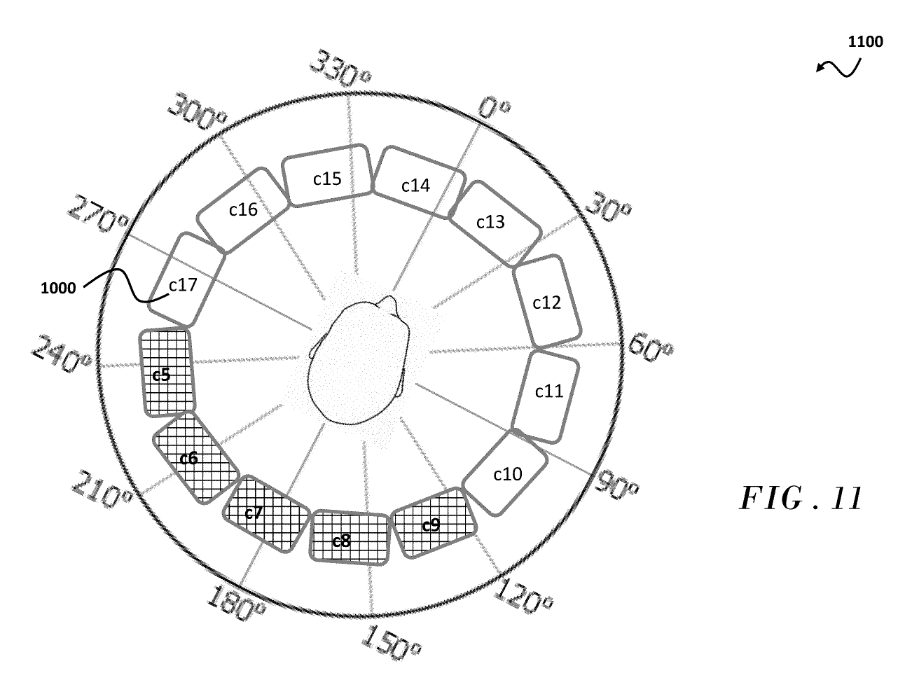

With reference to FIG. 11, the present invention further reduces sensors loaded to memory 914 from the stored 916 adjacent sensors 1050 by predictively presenting only a portion of the available sensors to create a 360 scene. The largest area viewable by a user 1110 is two hundred and twenty degrees on the horizontal, one hundred and ten degrees for each eye. In the present example, sensors c10 to c14 would provide the visual images for the right eye and sensors c14 through c17 would present the simultaneous and adjacent images to the left eye. Although the camera mount 620 would capture the entire three hundred and sixty degree scenes on the horizontal, the present invention would not load the sensors c5 though c9, designated by hatching in the figure, to memory 914 for stitching into the scene. This reduces the frames per second by almost 40% on the horizontal. On the vertical plane, the same can be done by the display server 1290 to reduce the sensors' 1000 transmission fifty degrees superior and 70 degrees inferior.

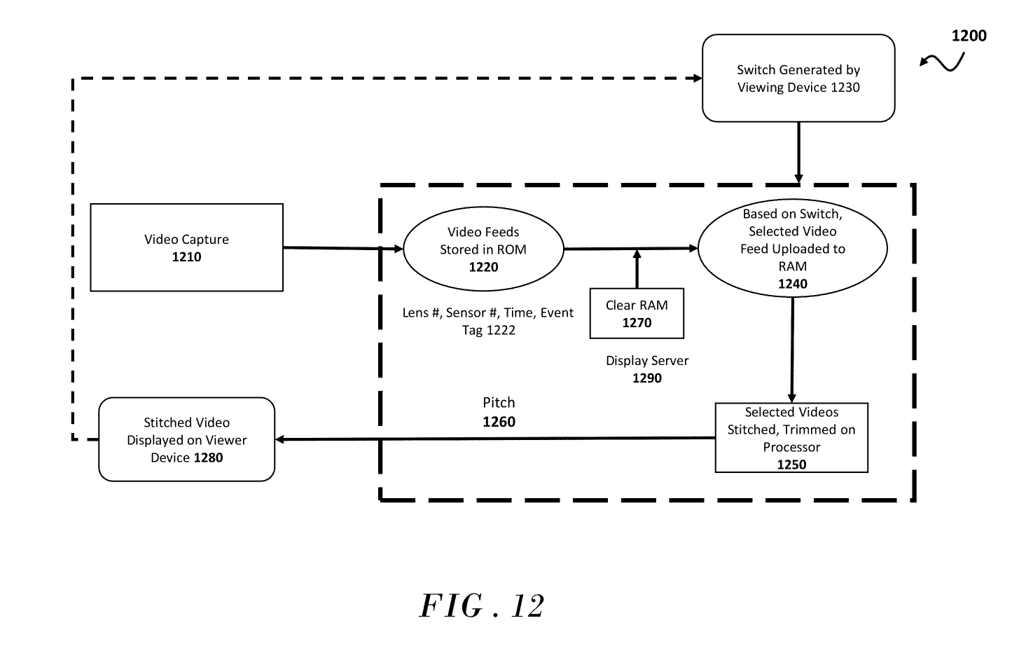

FIG. 12

Finally, turning to FIGS. 12, the flowchart demonstrates the use of the invention to generate a VR360 experience using a switch, ditch, stitch and pitch scheme.

The flowchart in FIG. 12 begins with the video capture 1210 from all the sensors 210 in the camera mount 220. Each sensor 210 is separately stored 916 on the display servers 1290. The storage of the video in ROM 1220 may include adding frame inventory tags that may comprise event identification tags 1222, scene index, lens number, sensor numbers and time. The videos are not combined in a pre-production process and remain stored as individual feeds on the storage of the display servers or associated storage mediums 916. Then, moving to the top of the flowchart, a switch is generated by the viewing device 1230 based on the action of the user 1110 of the viewing device 250. The switch 260 determines the composition of full sensor feeds 210 to the viewing device 250. Based on the switch 260, a new selected video feed is chosen from the sensor feeds stored on the server 1290 by selecting the associated event identification tags 1225. A portion of those feeds may already be stored in memory 914. Other sensors would be added to the memory and a portion of the RAM would be cleared 1270, or ditched, of any sensors not ordered for the scene. The selected adjacent sensors 1050 stored on the server 1290 would be trimmed, if required for the video configuration, and stitched on the processor 1250. The processor would then add a center point 1050 to represent the location that represents the middle of the viewing device 250. The result is two frames, for the L/R images, that can be pitched 1260 to the viewing device 250 over a communications link 928. Using the center point 1050, the frames are then displayed on the viewing device 1280. The display server then waits for a switch 260 from the viewing device 1230. Until a new switch is detected, the sequential frames from the same stitched are displayed on the viewing device 1280.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

In the foregoing description, and the following claims, method steps and/or actions are described in a particular order for the purposes of illustration. It should be appreciated that in alternate embodiments, the method steps and/or actions may be performed in a different order than that described. Additionally, the methods described above may be embodied in machine-executable instructions stored on one or more machine-readable mediums, such as disk drives, thumb drives or CD-ROMs. The instructions may be used to cause the machine (e.g., computer processor) programmed with the instructions to perform the method. Alternatively, the methods may be performed by a combination of hardware and software. While illustrative and presently preferred embodiments of the invention have been described in detail herein, it is to be understood that the inventive concepts may be otherwise variously embodied and employed, and that the appended claims are intended to be construed to include such variations, except as limited by the prior art.

Benefits, other advantages, and solutions to problems have been described herein with regard to specific embodiments. However, the advantages, associated benefits, specific solutions to problems, and any element(s) that may cause any benefit, advantage, or solution to occur or become more pronounced are not to be construed as critical, required, or essential features or elements of any or all the claims of the invention. As used herein, the terms “comprises”, “comprising”, or any other variation thereof, are intended to cover a non-exclusive inclusion, such that a process, method, article, or apparatus composed of a list of elements that may include other elements not expressly listed or inherent to such process, method, article, or apparatus.

### Advantages

From the description above, a number of advantages become evident for the “System and Method for Reducing System Requirements for a Virtual Reality 360 Display.” The present invention provides all new benefits for participating parties including the user and provider:
a) allows the user to reduce system requirements to display a VR360 experience;
b) allows the user to reduce data download expenses;
c) allows the user to reduce data download time;
d) allows the user a more seamless visual experience;
e) allows the provider to reduce storage requirements;
f) allows the provider to lower the cost of transmission.

What is claimed is:

1. A system for displaying a simulated VR360 streamed video, the system comprising:
a. a viewing device having a display screen and one or more sensors capable of generating a switch and a communication link;
b. one or more display servers configured to:
i. store individual video feeds from each sensor coupled with an identification tag;
ii. store a spatial map identifying adjacent sensors;
iii. provide a communication link to receive a switch from the viewing device;
iv. coupling the switch and spatial map data, identify a dynamically selected subset of adjacent sensor images when the switch is generated;
v. clear one or more addresses of a RAM to receive one or more sensors in the dynamically selected subset of adjacent senor images;
vi. in one or more RAM, stitch the one or more adjacent cells associated with the switch;
vii. determine a center point of the one more adjacent cells;
viii. provide a communication link to transmit the stitched sensor frames and the center point to the viewing device.
